(19) United States
(12) Patent Application Publication
(10) Pub. No.: US 2019/0173770 A1
(43) Pub. Date: Jun. 6, 2019

(54) METHOD AND SYSTEM FOR PLACEMENT OF VIRTUAL MACHINES USING A WORKING SET COMPUTATION

(71) Applicant: Nutanix, Inc., San Jose, CA (US)

(72) Inventor: Binny Sher GILL, San Jose, CA (US)

(73) Assignee: Nutanix, Inc., San Jose, CA (US)

(21) Appl. No.: 16/265,896

(22) Filed: Feb. 1, 2019

Related U.S. Application Data
(63) Continuation of application No. 14/296,049, filed on Jun. 4, 2014.

(51) Int. Cl. H04L 12/26; H04L 29/08

(52) U.S. Cl. CPC H04L 43/0876; H04L 67/1097

(57) ABSTRACT

A method and architecture for managing placement of a virtual machine onto a host in a virtualization environment comprises identifying a virtual machine (VM) for placement from a first host onto a different host, and placing the VM onto a second host, the second host selected based at least in part upon a cost corresponding to memory capacity and local storage capacity on the second host such that the cost is associated with displacement of second VM data of a second VM from the local storage on the second host to maintain the first VM data in the local storage on the second host rather than on the remote storage.

### CROSS REFERENCE TO RELATED APPLICATIONS

The present application is a continuation of U.S. patent application Ser. No. 14/296,049, filed on Jun. 4, 2014, entitled “METHOD AND SYSTEM FOR PLACEMENT OF VIRTUAL MACHINES USING A WORKING SET COMPUTATION”, which is related to U.S. Pat. No. 8,601,473, issued on Dec. 3, 2013, entitled “ARCHITECTURE FOR MANAGING I/O AND STORAGE FOR A VIRTUALIZATION ENVIRONMENT”, U.S. Pat. No. 8,850,130, issued on Sep. 30, 2014, entitled “METADATA FOR MANAGING I/O AND STORAGE FOR A VIRTUALIZATION ENVIRONMENT”, U.S. Pat. No. 8,549,518, issued on Oct. 1, 2013, entitled “METHOD AND SYSTEM FOR IMPLEMENTING A MAINTENANCE SERVICE FOR MANAGING I/O AND STORAGE FOR A VIRTUALIZATION ENVIRONMENT”, U.S. Pat. No. 9,009,106, issued on Apr. 14, 2015, entitled “METHOD AND SYSTEM FOR IMPLEMENTING WRITABLE SNAPSHOTS IN A VIRTUALIZED STORAGE ENVIRONMENT”, and U.S. patent application Ser. No. 13/207,375, filed on Aug. 10, 2011, entitled “METHOD AND SYSTEM FOR IMPLEMENTING A FAST CONVOLUTION FOR COMPUTING APPLICATIONS”, which are all hereby incorporated by reference in their entireties.

### FIELD

This disclosure concerns an architecture for performing placement of virtual machines in a virtualization environment using a working set computation.

### BACKGROUND

A “virtual machine” or a “VM” refers to a specific software-based implementation of a machine in a virtualization environment, in which the hardware resources of a real computer (e.g., CPU, memory, etc.) are virtualized or transformed into the underlying support for the fully functional virtual machine that can run its own operating system and applications on the underlying physical resources just like a real computer.

Virtualization works by inserting a thin layer of software directly on the computer hardware or on a host operating system. This layer of software contains a virtual machine monitor or “hypervisor” that allocates hardware resources dynamically and transparently. Multiple operating systems run concurrently on a single physical computer and share hardware resources with each other. By encapsulating an entire machine, including CPU, memory, operating system, and network devices, a virtual machine is completely compatible with most standard operating systems, applications, and device drivers. Most modern implementations allow several operating systems and applications to safely run at the same time on a single computer, with each having access to the resources it needs when it needs them.

Virtualization allows one to run multiple virtual machines on a single physical machine, with each virtual machine sharing the resources of that one physical computer across multiple environments. Different virtual machines can run different operating systems and multiple applications on the same physical computer.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine is not utilized to perform useful work. This is wasteful and inefficient if there are users on other physical machines which are currently waiting for computing resources. To address this problem, virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

In many current applications, VMs are run in clusters, each of which may comprise multiple VMs located on multiple hosts or servers. When creating a new VM to be deployed in the cluster, it is necessary to determine which host or server that the VM should be deployed to. The CPU, memory, and storage requirements of the VM should be compared to the available CPU, memory of the host, and the storage capacity of its associated data stores, in order to determine the most appropriate host onto which to place the VM.

In addition, during runtime it may also be desirable to move a VM from one host to another in order to improve performance. It is important to be able to choose the correct host to deploy the VM, in order to minimize impact on host resources and the performance of other VMs on the host.

Therefore, there is a need for an improved process for VM placement and moving.

### SUMMARY

Embodiments of the present invention provide an architecture for managing placement of a virtual machine onto a host in a virtualization environment. In some embodiments, one or more available hosts in the virtualization environment for which to place the virtual machine are identified. For each available host, a cost of placing the virtual machine may be determined, based at least in part upon a resource requirement for the virtual machine and a value of data currently associated with the host. Based at least in part on the calculated costs, a host for placing the virtual machine may be identified (e.g., the virtual machine is placed on the host having the lowest cost).

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

The drawings illustrate the design and utility of embodiments of the present invention, in which similar elements are referred to by common reference numerals. In order to better appreciate the advantages and objects of embodiments of the invention, reference should be made to the accompanying drawings. However, the drawings depict only certain embodiments of the invention, and should not be taken as limiting the scope of the invention.

FIG. 1 illustrates an example architecture of a cluster in a virtualization environment.

FIG. 2A illustrates an example architecture of a cluster implementing I/O and storage device management in a virtualization environment according to some embodiments.

FIG. 2B illustrates a controller VM of the cluster illustrated in FIG. 2A in accordance with some embodiments.

FIG. 3 illustrates a flowchart of a process for VM placement in a virtualization environment in accordance with some embodiments.

FIG. 4 illustrates a flowchart of process for VM movement in a virtualization environment in accordance with some embodiments.

FIG. 5 illustrates a flowchart of process for periodic VM movement in a virtualization environment in accordance with some embodiments.

FIG. 6 is a block diagram of a computing system suitable for implementing an embodiment of the present invention.

### DETAILED DESCRIPTION OF THE EMBODIMENTS OF THE INVENTION

Embodiments of the present invention provide an improved approach to performing placement of virtual machines in a virtualization environment using a working set computation. When placing a new VM in a cluster, or moving an existing VM, a determination must be made as to which host in the cluster the VM will be placed in or moved to. Typically, when a new VM is created, the CPU, memory, and storage requirements of the VM may be determined. Placement of the new VM into a host in the cluster has traditionally been determined using a dynamic resource scheduling (DRS) scheme, wherein the requirements of the VM are compared to the CPU and memory capacity of the available hosts, and the storage space on the data stores accessed by the host.

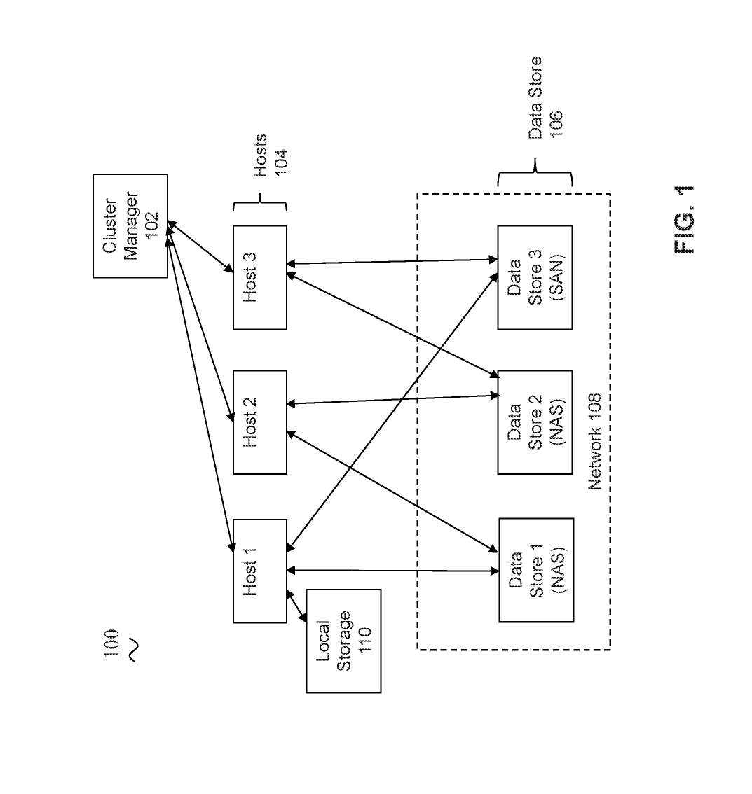

FIG. 1 illustrates a cluster 100 in a virtualization environment having a cluster manager 102 and a plurality of hosts 104, each of which may contain one or more VMs. The cluster manager 102 is responsible for keeping track of which VMs are on which hosts, initializing and placing new VMs onto a host, and managing movement of VMs between different hosts and data stores. The hosts 104 may access over network 108 a plurality of data stores 106, which may comprise network-attached storage (NAS) or storage area network (SAN). In some systems, hosts may also have their own local storage 110.

As illustrated in FIG. 1, host 1 is configured to connect with data store 1 and data store 3, host 2 connects with data stores 1 and 2, and host 3 connects with data stores 2 and 3. When a VM is to be placed on one of the hosts 104, its CPU, memory, and storage requirements are compared to the CPU and memory of the available hosts (e.g., hosts 1, 2, and 3), and the available space on their associated data stores (e.g., data stores 1 and 3 for host 1, data stores 1 and 2 for host 2, and data stores 2 and 3 for host 3).

In some cases, it is desirable for an existing VM to be moved from a first data store to a second data store. For example, if a VM experiences high latency accessing data on a first data store, but would have low latency if moved to a second data store, then the VM may be moved between the two data stores during the course of runtime. This process is traditionally known as Storage DRS.

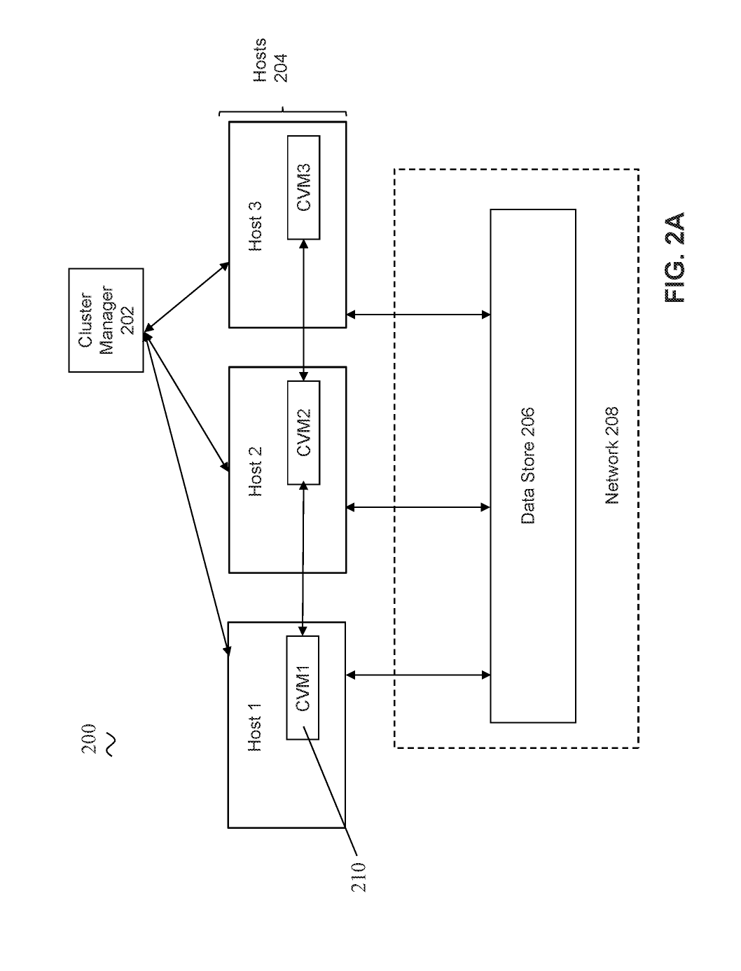

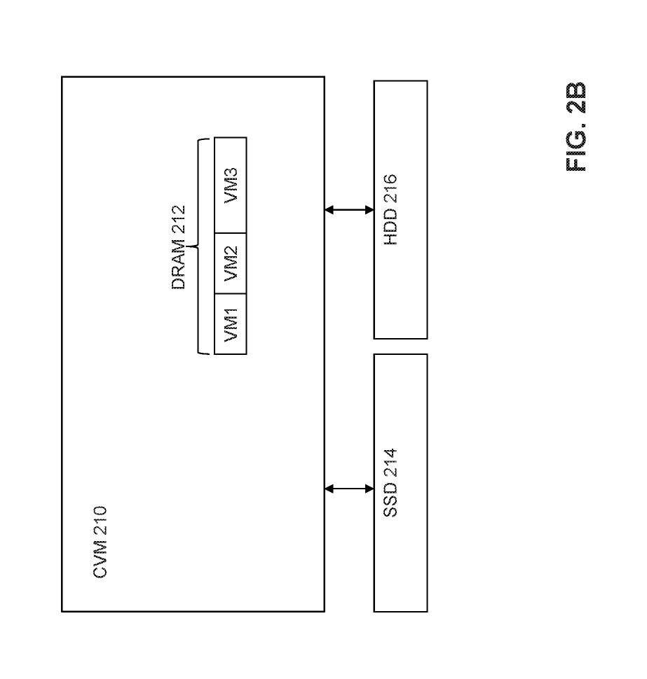

FIG. 2A illustrates a cluster 200 in a virtualization environment in accordance with some embodiments. Cluster 200 contains a cluster manager 202 and a plurality of hosts 204, wherein the hosts 204 may access a data store 206 over network 208. In some embodiments, because the hosts 204 access the same data store 206, storage may not be a concern when determining VM placement, as the storage capacity for all hosts will be the same. In some embodiments, each host 204 contains a controller VM 210 used to control access to the host's local storage, and to allow hosts to access local storage on other hosts by communicating with their respective controller VMs. Further details regarding methods and mechanisms for implementing I/O requests between user VMs and Service VMs, and for implementing the modules of the Service VM are disclosed in U.S. Pat. No. 8,601,473, which is hereby incorporated by reference in its entirety.

FIG. 2B illustrates a controller VM 210 in accordance with some embodiments. Controller VM 210 controls access from the VMs on host 204 to local storage, which may include DRAM (dynamic random access memory) 212, SSDs (solid state drives) 214, and HDDs (hard disk drives) 216. In some embodiments, DRAM 212 is used to store the metadata for the host 204 (e.g., which VMs reside on the host, how data for the VMs is stored, etc.). Because the I/O performance for SSDs is generally much faster compared to HDDs and networked storage, SSDs 214 may be used as a performance tier cache for a working set for the VMs, with an amount of space allocated to each of the VMs residing on the host 204.

While VMs on a host 204 are able to access data from data store 206 or local data on any of the other hosts 204 through their respective controller VMs 210, it is preferred for performance reasons that the VMs primarily access the local storage associated with the host on which they reside. This is because the sending of I/Os over the network would negate the performance advantage from using the SSDs. It will be understood that while the specification will refer primarily to SSDs, other types of storage (e.g., Flash) may be used in some embodiments to implement a cache or working set for the VMs in the virtualization environment cluster.

Thus, when creating a new VM to be placed on a host 204 in cluster 200, in addition to CPU, and memory as used in conventional DRS, additional factors such as availability of local storage (e.g., SSD, DRAM storage space) should also be considered. For example, it would be generally preferable for new VMs to be placed on hosts 204 having space available on their corresponding SSDs 214, instead of on hosts that do not. However, in many running systems, it is likely for the SSDs to be full on all hosts, and thus in order to determine which host the VM should be placed on, it may be necessary to determine the “value” or “cost” of the virtual machine data that would be displaced from the SSD of a particular host if the new VM was added to the host.

In some embodiments, the value of the data that would be displaced by the placement of a new VM on the host is a factor used to calculate a cost, or “marginal utility,” of placing a VM on a particular host. By comparing the costs for different available hosts, it can be determined onto which host the new VM should be placed (e.g., place the new VM onto the host where the associated cost is the lowest).

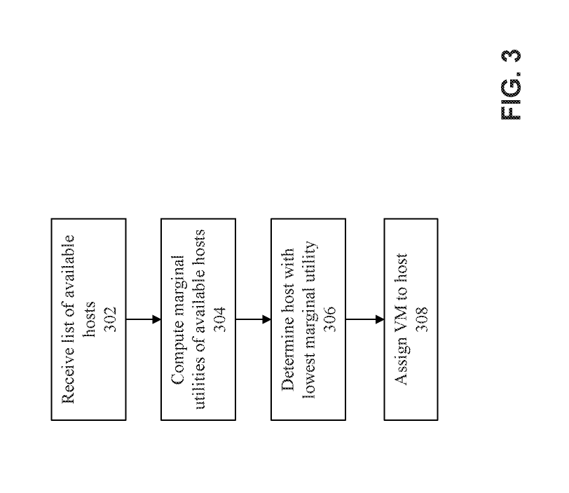

FIG. 3 illustrates a flowchart of a process for VM placement in accordance with some embodiments. At 302, a list of available hosts onto which a VM may be placed is received. The available hosts may be, in some embodiments, all of the hosts in the cluster.

In some embodiments, resource availabilities of the hosts, such as CPU and memory capacity, are considered in order to determine which hosts are available. For example, CPU and memory capacity may be used as threshold factors, wherein any hosts that do not satisfy the CPU and/or memory requirements of the new VM are not considered available for the placement of the new VM. In some embodiments, CPU and memory capacity of the hosts may instead be used as factors to calculate the costs of VM placement or marginal utilities of the hosts, instead of a threshold measurement.

In some embodiments, the available hosts may be determined based on one or more received inputs. For example, a user or system administrator may designate certain hosts as being available for the placement of new VMs, or exclude certain hosts from receiving any additional VMs.

At 304, the costs or marginal utilities of the available hosts are calculated. In some embodiments, the cost or marginal utility is determined based upon the “value” of the data on the host's SSD that would be displaced if the new VM is placed on the host, as it is generally desirable for the new VM to replace data on SSDs that is less “valuable.” If the SSD of a host has additional space allowing for placement of the new VM without having to replace existing data, then the “value” would be 0. However, if there is not enough additional space on the SSD such that the new VM can be placed on the host without displacing existing virtual machine data on the SSD, the value of data may be determined based upon when or how often the data has been accessed.

For example, in some embodiments, the value of data may be determined based upon an LRU (least recently used) scheme, such that the data on the SSD that is the least recently accessed would be considered to have lower value. In some embodiments, hit ratios (e.g., how often a particular segment of data on the SSD has been accessed in a certain period of time) may be used to determine the data on the SSD to be replaced, wherein the data with the lowest hit ratio may be designated to be displaced if a new VM is placed on the host. In some embodiments, the value of data may also be based upon a priority of a VM that the data is associated with. For example, a user can give priority to certain VMs such that data associated with the VM has higher value compared to data associated with other VMs.

In some embodiments, other factors may also be considered instead of or in addition to the value of data on the SSD. These factors may include a value of data on the host's DRAM that would be replaced, the host's CPU capacity, and/or the host's memory capacity (as described above). In some embodiments, the marginal utility for placing a new VM on a host is computed by assigning each factor a weight and aggregating the weighted factors for each available host.

The resource requirement of the VM may be used to calculate the cost of placing or moving the VM to a host. For example, if a VM to be moved has a very small impact on the SSD of its current host, then the expected cost of the move to the new host will be lower. Thus the cost of placing/moving a VM onto a host may be based upon the cost of resources on the host on a per unit basis, and the number of units needed by the VM. For example, in some embodiments, the cost of placing a VM on a host may be expressed by:

$$U = {\sum }_{i = 1}^{k} {W}_{i} {C}_{i} {N}_{i}$$

wherein U is the marginal utility of the host, Wᵢ corresponds to a weighting factor for a type of resource (e.g., CPU, memory, DRAM, SSD, etc.), Cᵢ corresponds to the cost of the resource on the host (e.g., cost of data on the host SSD that would be displaced by the new VM), and Nᵢ corresponds to the amount of the resource needed by the VM (e.g., amount of SSD data that would be displaced).

When placing a new VM onto a host in a cluster, the amount of resources (e.g., CPU, memory, and storage space) needed by the VM may be estimated, as the amount of resources the VM will actually consume may not yet be known. The estimate may be a default value for all VMs, be entered by a user or administrator creating the VM, or be based upon a class of workload associated with the VM or other characteristics of the VM.

However, when moving an existing VM to a different host, the amount of resources (CPU, memory, DRAM space, SSD space) used by the VM is easier to determine, as it may be based upon the resource usage of the VM at the time of the move. When a VM is to be moved to a new host, these resource requirements may be passed to the available hosts for evaluating the cost of a potential move.

At 306, once the costs or marginal utilities of the available hosts are calculated, the host having the lowest cost or marginal utility is identified. In some embodiments, this is accomplished by sorting the lists of available hosts by their calculated costs or marginal utilities. At 308, the VM is placed on the identified host.

During runtime of the cluster, the size of the workloads of the various VMs may change. For example, the SSDs on particular hosts may become very “hot,” with a large number of I/Os from the VMs on the host, while the data on SSDs on other hosts may not be so frequently accessed. In order to improve performance of the VMs, a VM may be moved from a hot host and onto to a host having less activity.

In some embodiments, the movement of VMs between hosts in the cluster may be based upon the utilization of the host. For example, a host experiencing utilization or activity above a threshold level may be considered a “hotspot.” When a host that is a hotspot is identified, the VMs on the host may be examined as candidates for moving to a new host.

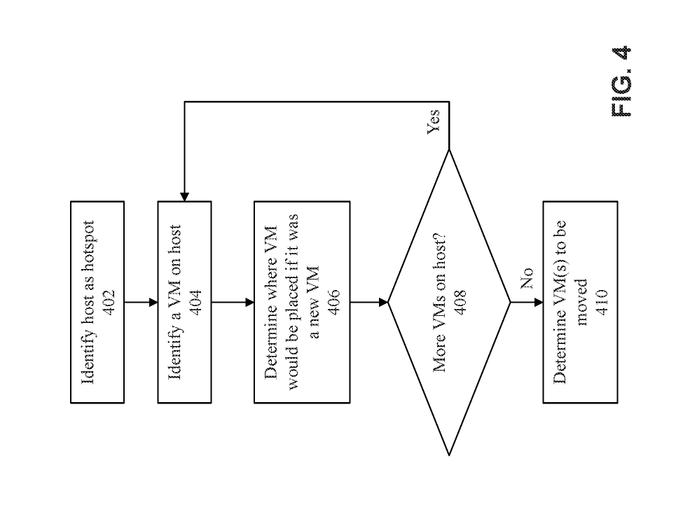

FIG. 4 illustrates a process for moving VMs by identifying hotspots in accordance with some embodiments. At 402, a host in the cluster is identified as a hotspot. The identification may be based upon at least one of the plurality of resource types used to calculate the cost of VM placement. For example, in some embodiments a host may be identified as a hotspot if the number of I/Os to the host's SSD in a certain period of time exceeds a predetermined threshold, or if the CPU usage of the host reaches a predetermined threshold.

At 404, a VM on the host is identified. At 406, the cost of moving the identified VM to another host is determined. In some embodiments, this determination is made by calculating the cost of placing the VM into the cluster as if it were a new VM (e.g., using the process illustrated in FIG. 3). In some cases it is possible to determine that the VM should be placed on the host that it is currently on.

At 408, a determination is made as to whether there are other VMs residing on the host. If there are, another VM is identified and its cost for moving is calculated, until all VMs on the host have been processed. In some embodiments, not all VMs on the host are processed. For example, certain VMs on the host may be designated as not available for moving. In other embodiments, the process may stop once a VM on the host is found having a moving cost that is less than a predetermined threshold.

At 410, a determination is made as to which VM to move, based on the costs calculated for each of the VMs on the host. In some cases, if the VM to be moved has been determined to be best placed on its current host, no VM movement occurs. In some embodiments, after each VM movement (or lack thereof), the cluster may wait for a predetermined amount of time before it resumes checking for hotspots.

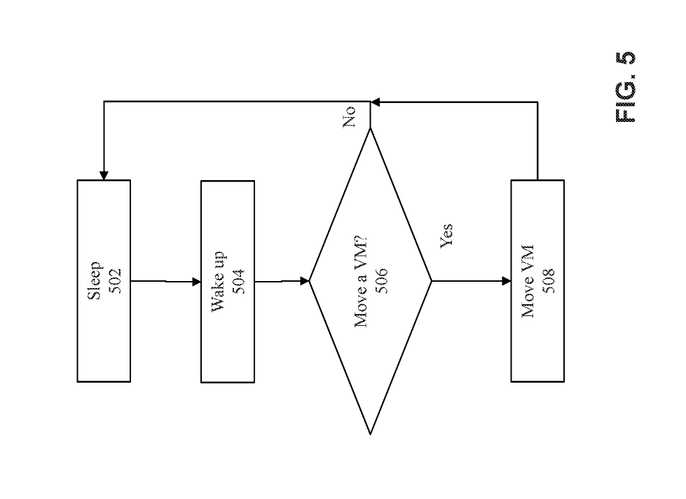

In other embodiments, movement or reshuffling of VMs may be managed periodically. FIG. 5 illustrates a process for periodically moving VMs in accordance with some embodiments. At 502, the process is asleep or inactive for a predetermined amount of time. In some embodiments, VM re-shuffling may be configured to happen once every hour or every day. At 504, at the end of the periodic time period, the system wakes up to determine if any of the VMs should be reshuffled.

At 506, a determination is made as to whether a VM should be moved. In some embodiments, whether a VM should be moved may be based upon how “hot” the VM is at the time (e.g., amount of I/Os from the VM). In some embodiments, all VMs in the cluster may be checked, while in other embodiments, only VMs on certain hosts are checked (e.g., VMs on hosts having the greatest activity level), or certain VMs meeting threshold requirements (e.g., activity level exceeds a threshold). In some embodiments, a predetermined number of VMs may be moved during each period, while in other embodiments, only VMs that meet certain threshold requirements are moved.

If it is determined at the no VM needs to be moved, the process returns to 502 and goes back to sleep. If it is determined at a VM should be moved, the VMs that have been determined should be moved are moved to different hosts at 508.

It will be understood that in some embodiments, both periodic reshuffling and monitoring of hotspots may be used. For example, a cluster may periodically check for a need to move VMs, while responding immediately if a particular host has been determined to be a hotspot.

In some clusters in accordance with the embodiments, the resource requirements for a VM may change depending on the host. For example, in some embodiments VM data may be written on multiple hosts. For example, a particular VM residing on host1 may write data to the SSD of host1, but may also write some duplicate data on the SSDs of other hosts as well. When calculating the cost of moving a VM to a different cost, the amount of duplicated data on the other host is considered when determining how much SSD space is needed on the host. For example, if a VM1 on host1 on requires 1 GB of SSD space, but already has 0.25 GB of data stored on host2, but no duplicate data on host3, then when determining the cost of moving VM1 to host2, the value of only 0.75 GB on host2 needs to be considered, while the full 1 GB must be considered for host3. Thus, other factors being equal, it would be preferable to move VM1 to host2 instead of host3 as less data would need to be replaced on host2.

Therefore, what has been described is an improved architecture for determining VM placement and movement in a virtualization environment.

### System Architecture

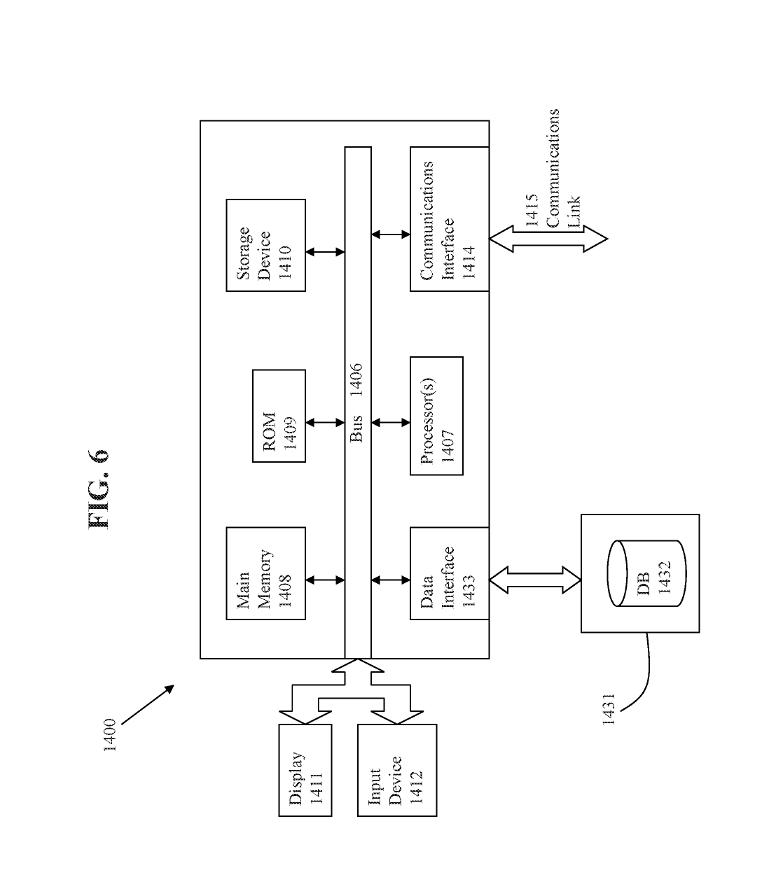

FIG. 6 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method comprising:
identifying a virtual machine (VM) for placement from a first host onto a different host, the VM comprising first VM data; and
placing the VM onto a second host, the second host selected based at least in part upon a cost corresponding to memory capacity and local storage capacity on the second host, wherein the first host and second host access (a) local storage attached to the first host and second host, respectively, and (b) remote storage attached to one or more other respective hosts,
wherein the cost is associated with displacement of second VM data of a second VM from the local storage on the second host to maintain the first VM data in the local storage on the second host rather than on the remote storage, and a controller virtual machine manages access by the VM to both the local storage and the remote storage.

2. The method of claim 1, wherein the cost corresponding to the local storage capacity is configured to weigh different types of storage devices differently.

3. The method of claim 2, wherein a type of storage device is a solid state drive (SSD).

4. The method of claim 1, wherein the VM is placed on the second host based at least in part on a lowest cost as compared to other available hosts.

5. The method of claim 1, wherein the cost corresponding to the local storage capacity is zero when a host has available local storage allowing for placement of the virtual machine without having to displace existing virtual machine data from the local storage of the host.

6. The method of claim 1, wherein the cost corresponding to the local storage capacity corresponds to an amount of data stored on an SSD.

7. The method of claim 1, wherein one or more available hosts are identified based at least in part upon a local storage requirement of the virtual machine and local storage capacities of the one or more available hosts.

8. A system comprising:
a computer processor to execute a set of program code instructions; and
a memory to hold the program code instructions, in which the program code instructions comprises program code to perform:
identifying a virtual machine (VM) for placement from a first host onto a different host, the VM comprising first VM data, and
placing the VM onto a second host, the second host selected based at least in part upon a cost corresponding to memory capacity and local storage capacity on the second host, wherein the first host and second host access (a) local storage attached to the first host and second host, respectively, and (b) remote storage attached to one or more other respective hosts,
wherein the cost is associated with displacement of second VM data of a second VM from the local storage on the second host to maintain the first VM data in the local storage on the second host rather than on the remote storage, and a controller virtual machine manages access by the VM to both the local storage and the remote storage.

9. The system of claim 8, wherein the cost corresponding to the local storage capacity is configured to weigh different types of storage devices differently.

10. The system of claim 9, wherein a type of storage device is a solid state drive (SSD).

11. The method of claim 1, wherein the VM is placed on the second host based at least in part on a lowest cost as compared to other available hosts.

12. The system of claim 8, wherein the cost corresponding to the local storage capacity is zero when a host has available local storage allowing for placement of the virtual machine without having to displace existing virtual machine data from the local storage of the host.

13. The system of claim 8, wherein the cost corresponding to the local storage capacity corresponds to an amount of data stored on an SSD.

14. The system of claim 8, wherein one or more available hosts are identified based at least in part upon a local storage requirement of the virtual machine and local storage capacities of the one or more available hosts.

15. A computer program product embodied in a non-transitory computer readable medium, the computer readable medium having stored thereon a sequence of instructions which, when executed by a processor causes the processor to execute a process comprising:
identifying a virtual machine (VM) for placement from a first host onto a different host, the VM comprising first VM data; and
placing the VM onto a second host, the second host selected based at least in part upon a cost corresponding to memory capacity and local storage capacity on the second host, wherein the first host and second host access (a) local storage attached to the first host and second host, respectively, and (b) remote storage attached to one or more other respective hosts,
wherein the cost is associated with displacement of second VM data of a second VM from the local storage on the second host to maintain the first VM data in the local storage on the second host rather than on the remote storage, and a controller virtual machine manages access by the VM to both the local storage and the remote storage.

16. The computer program product of claim 15, wherein the cost corresponding to the local storage capacity is configured to weigh different types of storage devices differently.

17. The computer program product of claim 16, wherein a type of storage device is a solid state drive (SSD).

18. The computer program product of claim 15, wherein the VM is placed on the second host based at least in part on a lowest cost as compared to other available hosts.

19. The computer program product of claim 15, wherein the cost corresponding to the local storage capacity is zero when a host has available local storage allowing for placement of the virtual machine without having to displace existing virtual machine data from the local storage of the host.

20. The computer program product of claim 15, wherein the cost corresponding to the local storage capacity corresponds to an amount of data stored on an SSD.

21. The computer program product of claim 15, wherein one or more available hosts are identified based at least in part upon a local storage requirement of the virtual machine and local storage capacities of the one or more available hosts.
